(19) United States
(12) Patent Application Publication
(10) Pub. No.: US 2024/0103878 A1
(43) Pub. Date: Mar. 28, 2024

(54) SHORT PIPELINE FOR FAST RECOVERY FROM A BRANCH MISPREDICTION

(71) Applicant: Intel Corporation, Santa Clara, CA (US)

(72) Inventors: Jayesh Gaur, Bangalore (IN); Sufiyan Syed, Chennai (IN); Adithya Ranganathan, Bengaluru (IN); Sreenivas Subramoney, Bangalore (IN)

(73) Assignee: Intel Corporation, Santa Clara, CA (US)

(21) Appl. No.: 17/953,184

(22) Filed: Sep. 26, 2022

(51) Int. Cl. G06F 9/38

(52) U.S. Cl. CPC G06F 9/3861; G06F 9/3867; G06F 9/3806

(57) ABSTRACT

An example of an integrated circuit may include a first execution cluster, a second execution cluster that is one or more of narrower and shallower as compared to the first execution cluster, and circuitry to selectively steer instructions to the first execution cluster and the second execution cluster based on branch misprediction information. Other embodiments are disclosed and claimed.

### BACKGROUND

Some central processor unit (CPU) cores may utilize speculative execution to avoid pipeline stalls and achieve better performance, which allows execution to continue without having to wait for the architectural resolution of a branch target. Branch prediction technology utilizes a digital circuit that guesses which way a branch will go before the branch instruction is executed. Correct predictions/guesses improve the flow in the instruction pipeline. In general, a branch prediction for a conditional branch may be understood as a prediction for the branch as “taken” vs. “not-taken.” A branch prediction unit (BPU) may support speculative execution by providing branch prediction for a frond-end of a CPU based on the branch instruction pointer (IP), branch type, and the control flow history (also referred as branch history) prior to the prediction point.

There is an ongoing need for improved computational devices to enable ever increasing demand for modeling complex systems, providing reduced computation times, and other considerations. In particular, there is an ongoing desire to improve branch prediction structures that are included in or otherwise support operation of integrated circuits. It is with respect to these and other considerations that the present improvements have been needed. Such improvements may become critical as the desire to improve computational efficiency become even more widespread.

### BRIEF DESCRIPTION OF DRAWINGS

Various examples in accordance with the present disclosure will be described with reference to the drawings, in which:

FIG. 1 is a block diagram of an example of an integrated circuit in one implementation.

FIGS. 2A to 2C are illustrative diagrams of an example of a method in one implementation.

FIG. 3 is a block diagram of an example of an apparatus in one implementation.

FIG. 4 is a block diagram of another example of an apparatus in one implementation.

FIG. 5 is an illustrative diagram of another example of a method in one implementation.

FIG. 6 is an illustrative diagram of another example of a method in one implementation.

FIG. 7 is a block diagram of an example of an out-of-order processor in one implementation.

FIG. 8 illustrates an example computing system.

FIG. 9 illustrates a block diagram of an example processor and/or System on a Chip (SoC) that may have one or more cores and an integrated memory controller.

FIG. 10A is a block diagram illustrating both an example in-order pipeline and an example register renaming, out-of-order issue/execution pipeline according to examples.

FIG. 10B is a block diagram illustrating both an example in-order architecture core and an example register renaming, out-of-order issue/execution architecture core to be included in a processor according to examples.

FIG. 11 illustrates examples of execution unit(s) circuitry.

FIG. 12 is a block diagram of a register architecture according to some examples.

FIG. 13 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for fast recovery from a branch misprediction. According to some examples, the technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to decode and execute instructions.

In the following description, numerous details are discussed to provide a more thorough explanation of the examples of the present disclosure. It will be apparent to one skilled in the art, however, that examples of the present disclosure may be practiced without these specific details. In other instances, well-known structures and devices are shown in block diagram form, rather than in detail, in order to avoid obscuring examples of the present disclosure.

Note that in the corresponding drawings of the examples, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary examples to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the examples of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Branch mispredictions may be a bottleneck for processors because there is a penalty on branch misprediction. To reduce the misprediction penalty, some approaches may involve improving branch predictor accuracy to reduce the number of branch mispredictions. A problem is that improved branch predictor accuracy may have a diminishing impact because of data dependent, hard to predict (H2P) branches. Another approach includes auto-predication of critical branches (ACB), that relies on dynamic predication. A problem is that ACB may have a limited applicability to only re-converging H2P branches. Another approach includes selective flushing, that reuses useful and correct control-independent-data-independent (CIDI) execution after a branch misprediction. A problem is that selective flush also relies on re-convergence and has a limited applicability. In cases of non-re-convergence, selective flush cannot reduce the fetch latency on a misprediction.

Another approach may be to reduce the misprediction penalty may involve reducing the impact of branch mispredictions. The performance penalty from some branch mispredictions may be broken down as follows: 1) the latency of the front-end fetch (e.g., the time to fetch the correct path on a branch misprediction as well as the fetch latency to allocate the mis-predicting branch); and 2) the pipeline latency of the out-of-order (OOO) core (e.g., the time to schedule and dispatch the mis-predicting branch as well as the time to schedule and dispatch the correct path that has been fetched, after a branch misprediction event). Some approaches to improved fetch latency involve using a micro-operation (uop) cache to help reduce fetch latency. A problem is that such front-end approaches do not address the back-end pipeline latency component of the performance penalty.

An approach to speeding up low instruction level parallelism (ILP) workloads may involve using criticality as a metric to speed up low ILP applications through a fast cluster. A data dependence graph-based training identifies a low ILP portion within a Mod-N like steering mechanism. The low ILP portion is then sent to a fast frequency cluster (e.g., twice as fast as other clusters). The target of this approach is application phases with low ILP that can be speeded up with the higher frequency of the fast cluster. A problem is that the dependence graph-based fast cluster is very coarse grained. Large segments of low ILP phases of the program are sent to the fast cluster. Another problem that the fast cluster has the same pipeline depth as the regular cluster. Other approaches may also involve criticality-based steering of uops across different clusters, to mitigate inter-cluster communication. A problem is that such approaches do not reduce a path length for recovery from branch misprediction.

Some examples described herein overcome one or more of the foregoing problems. Some examples provide technology to reduce a latency of the pipeline on the back-end. Some examples provide mitigation technology for the latency imposed by the long OOO schedule/dispatch pipeline. Some examples provide technology for a short pipeline for fast recovery from a branch misprediction. Some examples may provide more fine-grained technology where only a small number of uops are sent to a smaller cluster in a fine-grained manner (e.g., and where the smaller cluster has a shorter pipeline depth, as compared to the regular cluster), to reduce the pipeline latency impact on a branch misprediction.

Some examples may mitigate the back-end portion of the performance penalty from a branch misprediction by shortening the OOO pipeline latency for the uops that directly influence the branch misprediction penalty (e.g., uops that create sources for the mis-predicting H2P branch as well as correct path uops that are fetched after a branch misprediction event). An execution cluster may be nominally characterized by a width and a depth. For example, the width of the cluster may refer to a number of execution units, a number of inputs/ports, etc. For example, a depth of the execution cluster may refer to a size of the reservation stations, a number of steps/stages in the execution pipeline, etc. To create a shortened pipeline for these uops, some examples provide a small cluster with a small number of execution units (e.g., just two ports to simple integer execution units, where a port corresponds to a separate input for data to be processed by the respective execution clusters/units/circuits) and smaller reservation stations (e.g., one eighth (⅛^{th}) the size of the regular reservation stations). Effectively, an example of a small cluster may have a much shorter OOO pipeline/schedule latency because the small cluster has a smaller width/depth (e.g., the small cluster is narrower (less wide) and shallower (less deep) as compared to the regular clusters).

After a misprediction is detected, the right path instructions are sent to the small cluster. Additionally, low confidence branch instances of H2P branches and a limited portion of the back-slice uops may also be sent to the small cluster. Without otherwise limiting how the term back-slice (e.g., sometimes also referred to as a backward slice) may be understood by those skilled in the art, the back-slice may refer to all of the prior uops in the execution sequence that contribute, either directly or indirectly, to computation of a current uop, either through values or control decisions. Advantageously, some examples of a core with the short pipeline for fast recovery from a branch misprediction exhibit reduced branch misprediction latency and improved overall performance Reducing branch misprediction latency also advantageously reduces speculative uop execution and helps reduce power.

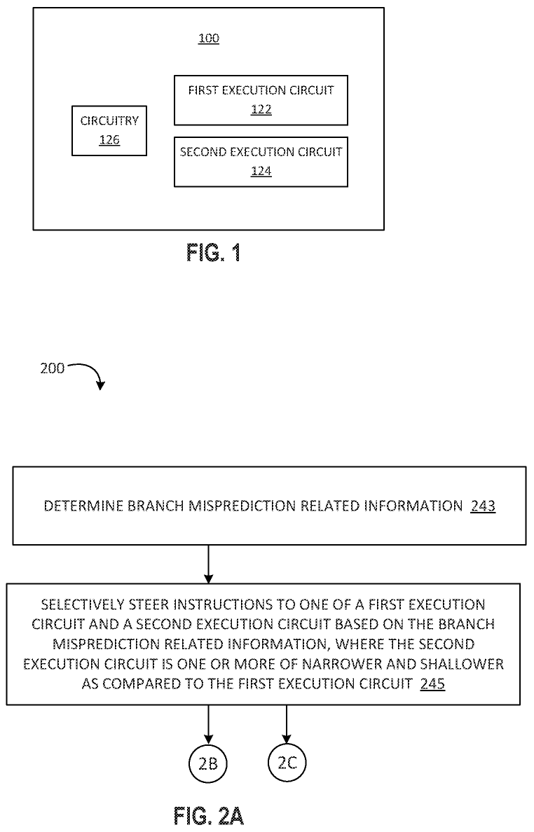

With reference to FIG. 1, an example of an integrated circuit 100 may include a first execution circuit 122 (e.g., a first execution cluster), a second execution circuit 124 (e.g., a second execution cluster) that is smaller (e.g., one or more of narrower and shallower) as compared to the first execution circuit 122, and circuitry 126 to selectively steer instructions to the first execution circuit 122 and the second execution circuit 124 based on branch misprediction information. In some examples, the circuitry 126 may be further configured to identify one or more instructions as part of a characteristic branch sequence (e.g., a H2P branch sequence, a post-misprediction branch sequence, etc.), and steer the identified one or more instructions to the second execution circuit 124. In one example, the circuitry 126 may be configured to identify a frequently mis-predicted branch (e.g., a H2P branch), form a back-slice chain of instructions that lead up to the frequently mis-predicted branch, and identify one or more instructions in the back-slice chain as part of the characteristic branch sequence (e.g., a H2P branch sequence) to be steered to the second execution circuit 124. In another example, additionally or alternatively, the circuitry 126 may be configured to identify a correct branch after a mis-predicted branch (e.g., a correct branch after a not-taken branch), and identify two or more instructions in the correct branch as part of the characteristic branch sequence to be steered to the second execution circuit 124.

In some implementations, the first execution circuit 122 may comprise eight (8) or more execution inputs (e.g. ports) and the second execution circuit 124 may comprise less than eight (8) execution inputs (e.g., four (4) or less execution inputs/ports). In some implementations, the first execution circuit 122 may comprise one hundred (100) or more reservation station (RS) entries per execution input/port and the second execution circuit 124 may comprise less than one hundred (100) RS entries per execution input/port (e.g., thirty two (32) or less RS entries per input/port). In some examples, the smaller (e.g., less wide and/or less deep) second execution circuit 124 may have a shorter pipeline of execution as compared to the first execution circuit 122.

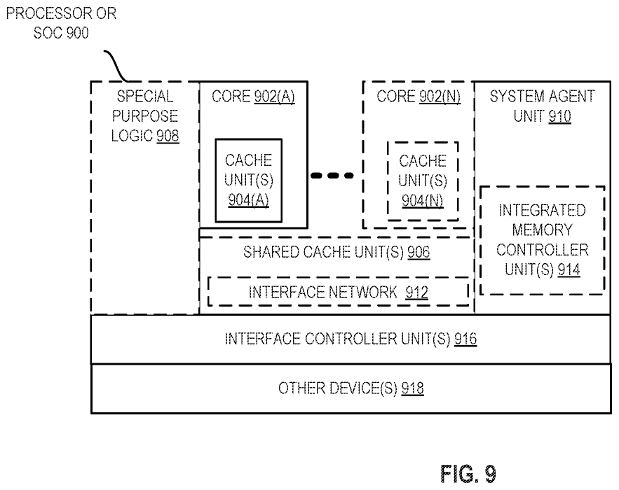

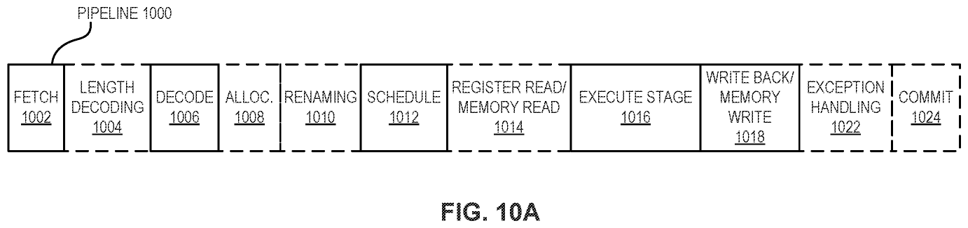

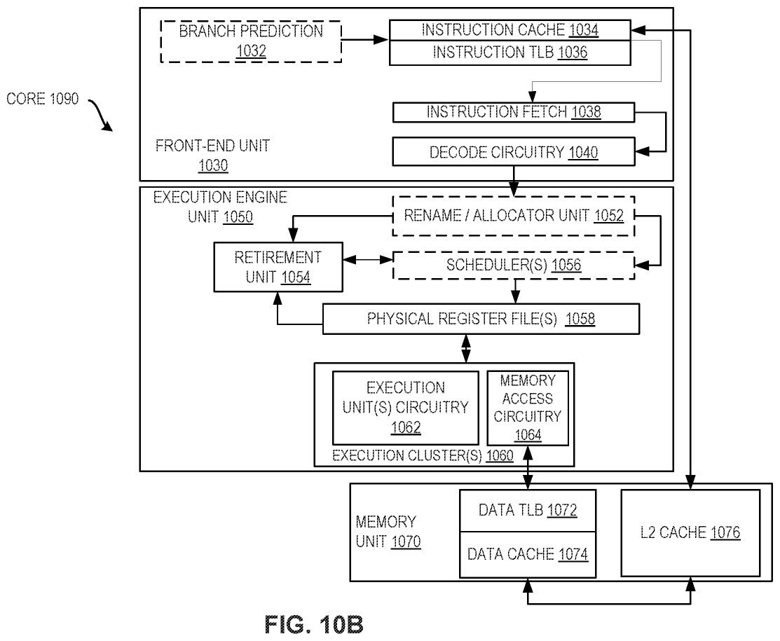

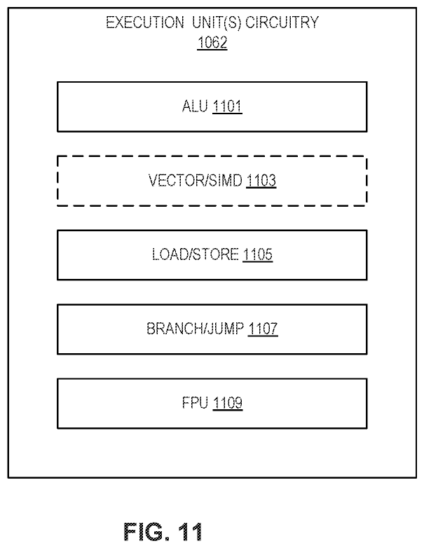

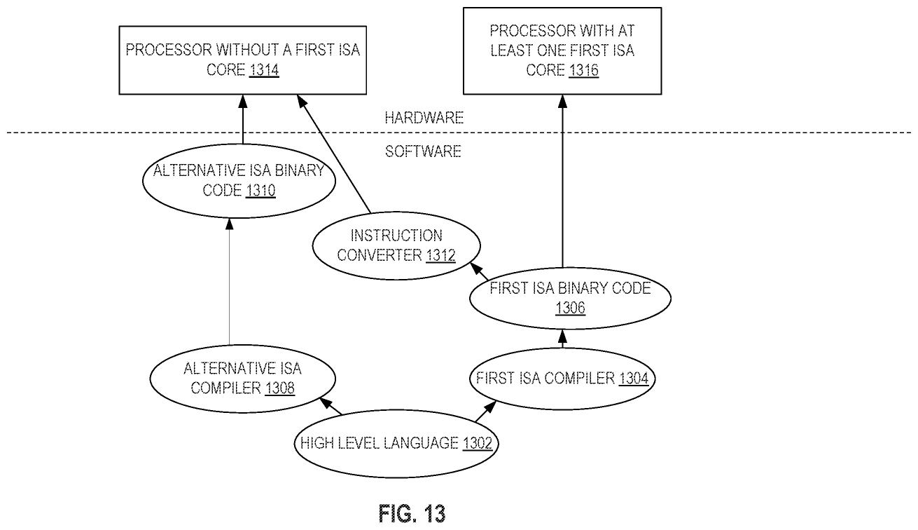

For example, the first execution circuit 122, the second execution circuit 124, and/or the circuitry 126 may be implemented/integrated/incorporated as/with/in any of the processors described herein. In particular, the first execution circuit 122, the second execution circuit 124, and/or the circuitry 126 may be implemented/integrated/incorporated as/with/in the processor 800, the processor 870, the processor 815, the coprocessor 838, and/or the processor/coprocessor 880 (FIG. 8), the processor 900 (FIG. 9), the core 1090 (FIG. 10B), the execution units 1062 (FIGS. 10B and 11), and the processor 1316 (FIG. 13). In some examples, the first execution circuit 122 and the second execution circuit 124 may be implemented by the execution clusters 1060 of the execution engine unit 1050.

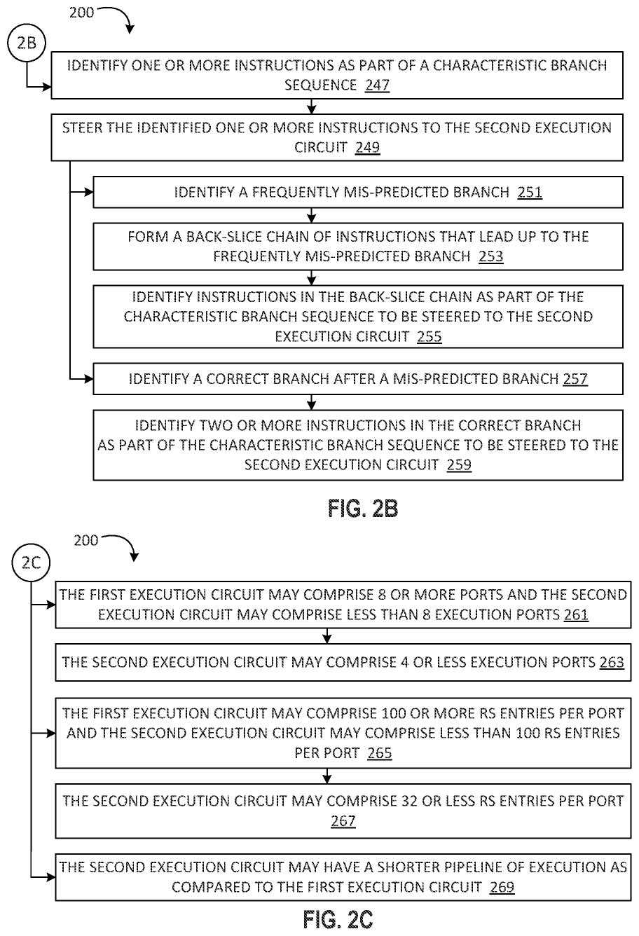

With reference to FIGS. 2A to 2C, an example of a method 200 may include determining branch misprediction information at box 243, and selectively steering instructions to one of a first execution circuit (e.g., a first execution cluster) and a second execution circuit (e.g., a second execution cluster) based on the branch misprediction information at box 245, where the second execution circuit is one or more of narrower and shallower as compared to the first execution circuit. In some examples, the method 200 may further include identifying one or more instructions as part of a characteristic branch sequence at box 247, and steering the identified one or more instructions to the second execution circuit at box 249. In one example, the method 200 may include identifying a frequently mis-predicted branch at box 251, forming a back-slice chain of instructions that lead up to the frequently mis-predicted branch at box 253, and identifying one or more instructions in the back-slice chain as part of the characteristic branch sequence to be steered to the second execution circuit at box 255. In another example, additionally or alternatively, the method 200 may include identifying a correct branch after a mis-predicted branch at box 257, and identifying two or more instructions in the correct branch as part of the characteristic branch sequence to be steered to the second execution circuit at box 259.

In some examples, the first execution circuit may comprise eight (8) or more execution ports and the second execution circuit may comprise less than eight (8) execution ports at box 261. For example, the second execution circuit may comprise four (4) or less execution ports at box 263. In some examples, the first execution circuit may comprise one hundred (100) or more RS entries per port and the second execution circuit may comprise less than one hundred (100) RS entries per port at box 265. For example, the second execution circuit may comprise thirty two (32) or less RS entries per port at box 267. In some examples, the second execution circuit may have a shorter pipeline of execution as compared to the first execution circuit at box 269.

For example, the method 200 may be performed by any of the processors described herein. In particular, the method 200 may be performed by the processor 800, the processor 870, the processor 815, the coprocessor 838, and/or the processor/coprocessor 880 (FIG. 8), the processor 900 (FIG. 9), the core 1090 (FIG. 10B), the execution units 1062 (FIGS. 10B and 11), and the processor 1316 (FIG. 13). In some examples, the first execution circuit and the second execution circuit may be implemented by the execution clusters 1060 in the execution engine unit 1050.

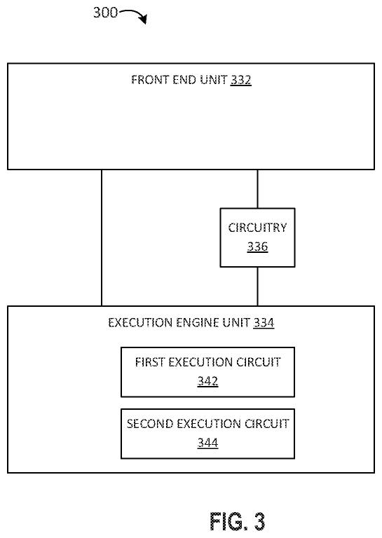

With reference to FIG. 3, an example of an apparatus 300 may include a front-end unit 332 to decode one or more instructions, an execution engine unit 334 communicatively coupled to the front-end unit 332 to execute one or more decoded instructions, the execution engine unit including a first execution circuit 342 (e.g., a first execution cluster) and a second execution circuit 344 (e.g., a second execution cluster) that is smaller (e.g., one or more of narrower and shallower) as compared to the first execution circuit 342, and circuitry 336 (e.g., steering logic) to selectively steer instructions to the first execution circuit 342 and the second execution circuit 344 based on branch misprediction information. In some examples, the circuitry 336 may be further configured to identify one or more instructions as part of a characteristic branch sequence (e.g., a H2P branch sequence, a post-misprediction branch sequence, etc.), and steer the identified one or more instructions to the second execution circuit 344. In one example, the circuitry 336 may be configured to identify a frequently mis-predicted branch (e.g., a H2P branch), form a back-slice chain of instructions that lead up to the frequently mis-predicted branch, and identify one or more instructions in the back-slice chain as part of the characteristic branch sequence (e.g., a H2P branch sequence) to be steered to the second execution circuit 344. In another example, additionally or alternatively, the circuitry 336 may be configured to identify a correct branch after a mis-predicted branch (e.g., a correct branch after a not-taken branch), and identify two or more instructions in the correct branch as part of the characteristic branch sequence to be steered to the second execution circuit 344.

In some implementations, the first execution circuit 342 may comprise eight (8) or more execution ports and the second execution circuit 344 may comprise less than eight (8) execution ports (e.g., four (4) or less execution ports). In some implementations, the first execution circuit 342 may comprise one hundred (100) or more RS entries per port and the second execution circuit 344 may comprise less than one hundred (100) RS entries per port (e.g., thirty two (32) or less RS entries per port). In some examples, the smaller (e.g., less wide and/or less deep) second execution circuit 344 may have a shorter pipeline of execution as compared to the first execution circuit 342.

For example, the front-end unit 332, the execution engine unit 334, the first execution circuit 342, the second execution circuit 344, and/or the circuitry 336 may be implemented/integrated/incorporated as/with/in any of the processors described herein. In particular, the first execution circuit 342, the second execution circuit 344, and/or the circuitry 336 may be implemented/integrated/incorporated as/with/in the processor 800, the processor 870, the processor 815, the coprocessor 838, and/or the processor/coprocessor 880 (FIG. 8), the processor 900 (FIG. 9), the core 1090 (FIG. 10B), the execution units 1062 (FIGS. 10B and 11), and the processor 1316 (FIG. 13). In some examples, the front-end unit 332 may be similarly configured as the front-end unit 1030 and the execution engine unit 334 may be similarly configured as the execution engine unit 1050 (e.g., with the first execution circuit 342 and the second execution circuit 344 implemented by the execution clusters 1060).

Some examples herein may advantageously reduce the penalty incurred by branch misprediction at the OOO engine. In one example, technology is provided to make the H2P branches that suffer frequent misprediction resolve/execute faster, thus shortening the amount of time spent in the wrong path. In another example, further technology is provided to make the first N set of uops from the right path (e.g., where N is greater than 1, but generally limited based on the size of the smaller cluster), after a branch misprediction event, schedule and execute faster, thus reducing the branch misprediction bubble.

To enable faster dispatch and execution, some examples provide a separate Branch Sequence Cluster (BSC) that has two-wide (2-wide) execution, sixteen (16) RS entries per port and only supports integer uops. The BSC is small compared to other execution clusters available to execute OOO instructions (e.g., the regular clusters). A small cluster such as the example BSC supports a shorter pipeline of execution than the regular OOO execution clusters (e.g., that may have eight (8) to sixteen (16) ports and three hundred or more (300+) RS entries per port). In some implementations, an example small execution cluster may require not more than half the number of pipeline stages, as compared to the regular OOO execution cluster. Advantageously, some example may essentially halve the execution and dispatch latency of the H2P branches.

Suitable steering logic/circuitry may determine or identify branch misprediction information and steer instructions to either the BSC or the regular execution cluster based on the branch misprediction information. For example, suitable steering logic/circuitry may monitor for any of a number of different characteristics in a sequence of instructions that result in a mis-predicted branch (e.g., a characteristic branch sequence). When a characteristic branch sequence results in a branch misprediction, the steering logic/circuitry may steer appropriate instructions to the BSC for faster execution to reduce the branch misprediction penalty.

For frequently mis-predicting branches, for example, suitable logic/circuitry may start forming the back-slice chain leading up to the branch and keep marking all the instructions in the chain as a H2P branch sequence (hbseq). All the hbseq instructions are fed to the BSC, eventually halving the dispatch and execution latency of these branches. In another example, the first N instructions from the right path after a branch misprediction are always fed to the BSC which halves their execution and dispatch latency, reducing the branch misprediction penalty.

Advantageously, some examples more improve one or more of efficiency, energy consumption, and performance. With respect to efficiency, only appropriate instructions are marked as characteristic branch sequences (e.g., the H2P branch, the back-slice chain associated with the H2P branch, the first N instructions after a branch misprediction event, etc.) and only the execution of the marked instructions is boosted to gain performance (e.g., a judicious and efficient use of the BSC). With respect to energy consumption, by resolving the H2P branch faster, the amount of time spent in the wrong path is reduced and the amount of unneeded fetch is reduced, saving energy.

As branch predictors improve and the number of cores widens, H2P branches may remain problematic in terms of dominating a workload and/or limiting processor scaling. Although branch predictors may continue to improve, a problem is that branch predictors may not perform well with H2P branches because of data dependent branches. Some examples may provide technology to reduce the branch misprediction penalty by resolving the misprediction quickly and/or flushing quickly. Some examples provide technology to mis-predict and resolve quickly, such that a bubble between retirements is not too big because the mis-predicting branch resolves much earlier before stalling retirement. Some examples provide further technology to get instructions into the OOO after a misprediction and get the instructions to execute quickly, to shorten the retirement bubbles.

Without being limited to principles of operation, mis-predicting branches may be more problematic when they stall retirement. A mis-predicting branch that does not stall retirement may not need to be resolved quickly. Some examples identify branches that take longer to execute due to data dependence chains and thus, stalls retirement when mis-predicted. To resolve faster, some examples accelerate the full back-slice of dependence chains starting from the mis-predicting branches. Because these instructions are data dependent, they don't benefit from increased width and depth and may be beneficially steered to the smaller execution cluster.

On a branch misprediction event, without being limited to principles of operation, the flush penalty may be a combination of the time to clean all the younger uops and the time for new right path instructions to trickle down to the OOO execution unit. In some implementations, the flush penalty may be a function of where in the re-order buffer (ROB) the branch misprediction happened. However, the flush may be accelerated by pushing incoming right path instructions to a shorter pipeline cluster for a set number of cycles. However, as more instructions are pushed into the shorter pipeline cluster, performance may be hindered because the smaller cluster is thinner than the regular cluster thus, limiting benefits from depth and width scaling. Some examples push up to a pre-determined number of incoming right path instructions to the smaller cluster to tradeoff between accelerating the flush and the performance of the regular cluster.

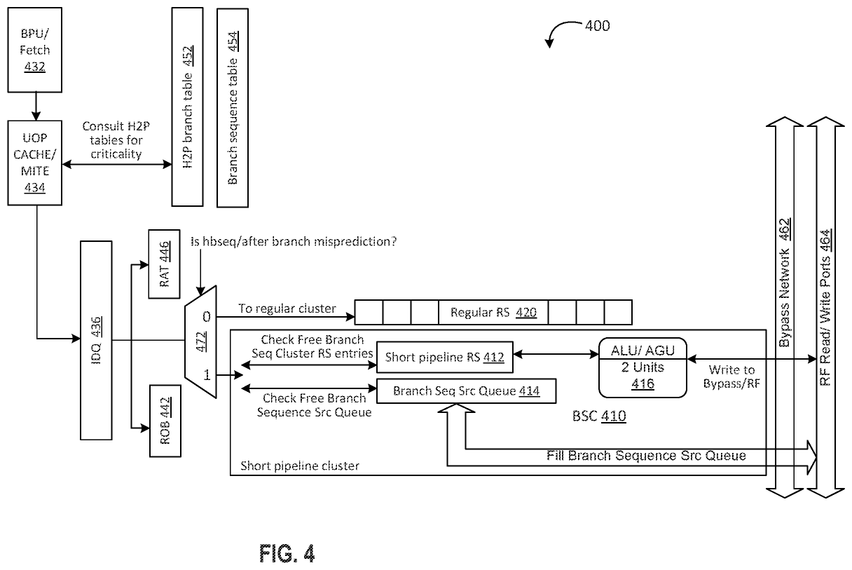

With reference to FIG. 4, an example apparatus 400 includes a BSC 410, a regular RS 420 for a regular execution cluster (not shown), a branch prediction unit (BPU)/fetch unit 432, a uop cache/MITE decode unit 434, a micro-op instruction/data queue (IDQ) 436, a ROB 442, a register alias table (RAT) 446, a H2P branch table 452, a branch sequence table (BST) 454, a bypass network 462, RF read/write ports 464, and a selector 472, coupled as shown. An example microarchitecture of the short pipeline BSC 410 includes a short pipeline RS 412, a branch sequence source queue 414 and two integer arithmetic logic unit (ALU)/address generation unit (AGU) units 416, coupled as shown.

The microarchitecture of the BSC 410 may support double pumped RS/INT operations. The branch sequence source queue 414 may be configured similar to a physical register file (PRF) for the hbseq uops. The branch sequence source queue 414 may read from the bypass network 462 and may have extra ports to read from PRF. At allocation, the ready sources are read so that the rest of the sources come only from the bypass network 462. In some examples, the contents of the BST 454 may include fields for a valid bit, a confidence counter, and tag bits.

In an example operation, branches that mis-predict and are close to the head of the ROB 442 at writeback are identified (e.g., the identified branches are most likely to stall retirement). A linear instruction pointer (LIP)-indexed table is maintained with mis-predicting branches and as the mis-predicting branches saturate the corresponding confidence counter in the BST 454, the mis-predicting branches are marked as hbseq (e.g., by setting a tag bit in the BST 454 to indicate that the instruction is part of a H2P branch sequence). For example, the H2P branch table 452 and the BST 454 are part of a hardware mechanism that may be utilized to identify one or more instructions in the back-slice chain as part of the hbseq (e.g., the characteristic branch sequence) to be steered to the BSC 410 (e.g., the short pipeline cluster).

After a branch has been marked as hbseq, when the same branch is next encountered, at writeback, the last completing source is added to the BST 454. Recursively, the full graph is built. Eventually when a uop is reached that is already in the BST, training is stopped. As the instructions get marked as hbseq, the instructions are sent to the BSC 410. With the shorter pipeline, execution of the mis-predicting branch is sped up may resolve quickly.

When a branch misprediction event happens, the OOO structures are flushed including any uops in the BSC 410 that are younger than the mis-predicting branch instruction. Thereafter, the incoming right path instructions are allocated into the shorter pipeline BSC 410 for a set number of cycles.

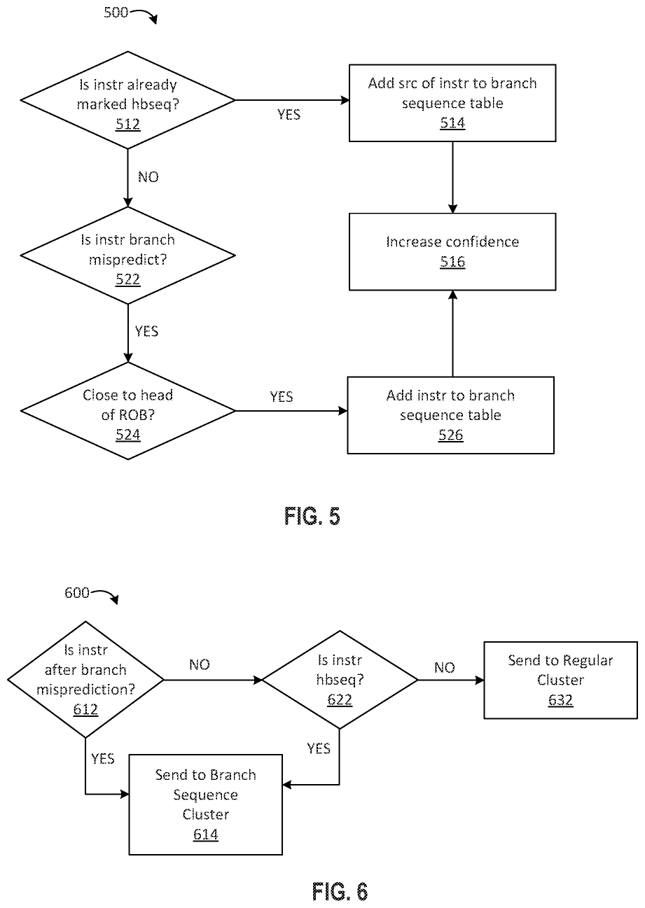

With reference to FIG. 5, an example of a method 500 may generally involve training for H2P branch sequence detection. At box 512, an instruction is checked for whether the instruction is already marked as hbseq. If so, the source of the instruction is added to the branch sequence table at box 514, and the confidence value in the branch sequence table is increased at box 516. Otherwise, the instruction is checked for whether the instruction is from a mis-predicted branch at box 522 and if the instruction close to the head of the ROB at box 524. If so, the instruction is added to the branch sequence table at box 526 and the confidence value in the branch sequence table is increased at box 516.

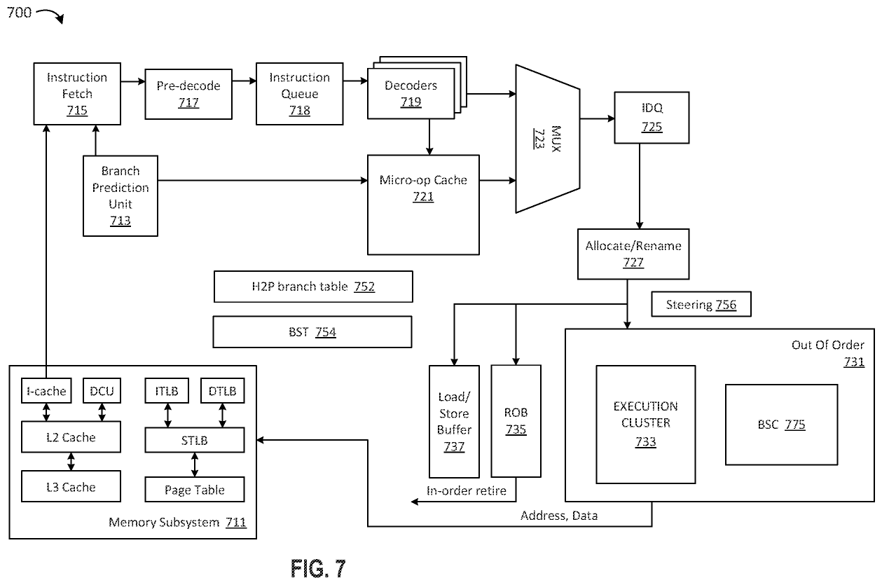

With reference to FIG. 6, an example of a method 600 generally involves steering instructions to a branch sequence cluster. At box 612, an instruction is checked for whether the instruction is after a branch misprediction event. If so, the instruction is sent to the branch sequence cluster at box 614. Otherwise, the instruction is checked for whether the instruction is marked at hbseq at box 622. If so, the instruction is sent to the branch sequence cluster at box 614. Otherwise, the instruction is sent to the regular cluster at box 632.

In an example regular uop flow (e.g., for any uop), the uop is checked for whether it hits in the H2P branch table or the BST, and for whether the confidence count from to the uop's corresponding entry in the BST is greater than a threshold. If not, the uop is marked as not hbseq and the ROB position is stored at allocation.

At writeback for mis-predicting branches, the current ROB position is checked. If the ROB position at allocation is greater than a threshold and the current position in the ROB is lower than a particular threshold, then the uop is considered to have been allocated very early but also to have taken very long to writeback thereby stalling its dependents from proceeding. Such early allocation and long writeback may also be due to the sources (back-slice) not completing either. At times, the uop may retire very close to the head of the ROB but may have been allocated also close to the head of the ROB (e.g., a branch misprediction/nuke). In some examples, uops exhibiting these conditions are ignored and not considered to match a suitable characteristic branch sequence for the BSC. Some implementations may further ignore specific instruction types/classes (e.g., AVX, FP, store instructions, etc.) because they do not match a suitable characteristic branch sequence for the BSC.

If at writeback for mis-predicting branches a uop is identified as hbseq, the LIP is added to the H2P branch table (e.g., that may sometimes be referred to as a learning table). The uop may then be found in the H2P branch table and a uop hits, the confidence counter is increased. If a LIP is identified as hbseq multiple times, indicated when the confidence counter is greater than a threshold, the uop is marked as hbseq at an allocation stage. Thereafter, a buffering technique such as the method 500 (FIG. 5) may be utilized and for hbseq uops, at writeback the last source to writeback is checked. The BST may be trained in a similar manner. When a LIP is marked as hbseq by being over a threshold, the corresponding producers are similarly trained. This procedure continues iteratively to get the full back-slice.

In an example uop flow, when the LIP corresponding to a uop is part of either the H2P branch table or the BST, for hbseq uops the BSC RS and Branch Sequence Source Queue (BSSQ) are checked for availability at allocation. If any of the needed resources are unavailable, the allocation is stalled. Otherwise, if the BSC RS and BSSQ are available, the uops are steered to the BSC. Then the BSC RS and BSSQ are allocated.

At wakeup and schedule, the uop is then steered to the right INT exe port and executed. The uop uses the source from the BSSQ and the bypass path (if necessary). Because of the nature of sequence, usually only one source is from BSSQ.

After execution, the result is passed onto the bypass path for the next uop in the dependent chain to execute. The output is also sent to the regular cluster through the bypass network where the PRF is written to. Because the execution is on the faster branch sequence cluster (e.g., at 2× frequency of regular cluster), the execution completes in half the time. Because the execution completes faster, the cycles may be pruned in every hbseq uop and thus, reduce the H2P branch sequence chain throughout. Advantageously, the pruning and reduction of the H2P branch sequence improves performance.

If the full workload is known to be made of H2P branch sequence chains of dependents, and the dependents are in the BSC, the rest of the core may be clock gated to save power. Also, because the BSC is itself very small, power is also saved for the uops executed on the BSC.

In an example branch misprediction flush flow, after a branch misprediction, for set number of cycles, all uops are marked as hbseq. Steering a set number of uops to the BSC after a branch misprediction reduces the pipeline cycles between allocation to dispatch and gets more uops into the pipeline quicker.

Examples described herein provide technology to identify branch mispredictions and reduce the flush penalty. Advantageously, some examples may outperform coarse-grained approaches for cluster steering mechanisms and saves power.

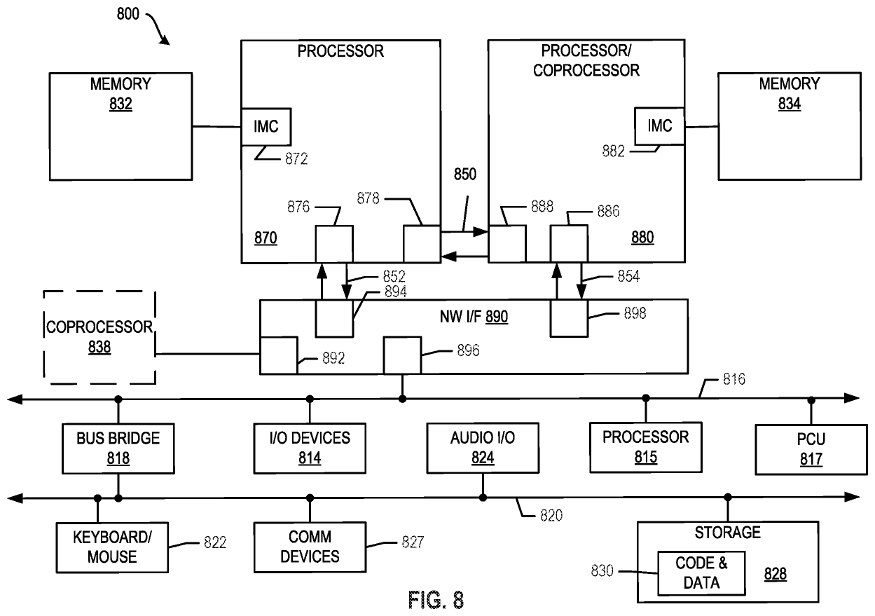

With reference to FIG. 7, an example of an OOO processor core 700 includes a memory subsystem 711, a BPU 713, an instruction fetch circuit 715, a pre-decode circuit 717, an instruction queue 718, decoders 719, a micro-op cache 721, a mux 723, an IDQ 725, an allocate/rename circuit 727, an out-of-order core 731, a re-order buffer (ROB) 735, and a load/store buffer 737, connected as shown. The memory subsystem 711 include a L1 instruction cache (I-cache), a L1 data cache (DCU), a L2 cache, a L3 cache, an instruction translation lookaside buffer (ITLB), a data translation lookaside buffer (DTLB), a shared translation lookaside buffer (STLB), and a page table, connected as shown. The OOO core 731 includes one or more execution core(s) 733 and at least one BSC 775. The microarchitecture of the OOO processor 700 further includes a H2P branch table 752, a BST 754, steering logic 756, and other circuitry, to make effective use of the BSC 775 to reduce branch misprediction latency as described herein.

Example Computer Architectures.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 8 illustrates an example computing system. Multiprocessor system 800 is an interfaced system and includes a plurality of processors or cores including a first processor 870 and a second processor 880 coupled via an interface 850 such as a point-to-point (P-P) interconnect, a fabric, and/or bus. In some examples, the first processor 870 and the second processor 880 are homogeneous. In some examples, first processor 870 and the second processor 880 are heterogenous. Though the example system 800 is shown to have two processors, the system may have three or more processors, or may be a single processor system. In some examples, the computing system is a system on a chip (SoC).

Processors 870 and 880 are shown including integrated memory controller (IMC) circuitry 872 and 882, respectively. Processor 870 also includes interface circuits 876 and 878; similarly, second processor 880 includes interface circuits 886 and 888. Processors 870, 880 may exchange information via the interface 850 using interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a network interface (NW I/F) 890 via individual interfaces 852, 854 using interface circuits 876, 894, 886, 898. The network interface 890 (e.g., one or more of art interconnect, bus, and/or fabric, and in some examples is a chipset) may optionally exchange information with a coprocessor 838 via an interface circuit 892. In some examples, the coprocessor 838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 870, 880 or outside of both processors, yet connected with the processors via an interface such as P-P interconnect, such that either or both processors' local cache information may be stored in the shared cache if a processor is placed into a low power mode.

Network interface 890 may be coupled to a first interface 816 via interface circuit 896. In some examples, first interface 816 may be an interface such as a Peripheral Component Interconnect (PCI) interconnect, a PCI Express interconnect or another I/O interconnect. In some examples, first interface 816 is coupled to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interface 816, along with a bus bridge 818 which couples first interface 816 to a second interface 820. In some examples, one or more additional processor(s) 815, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 816. In some examples, second interface 820 may be a low pin count (LPC) interface. Various devices may be coupled to second interface 820 including, for example, a keyboard and/or mouse 822, communication devices 827 and storage circuitry 828. Storage circuitry 828 may be one or more non-transitory machine-readable storage media as described below, such as a disk drive or other mass storage device which may include instructions/code and data 830. Further, an audio I/O 824 may be coupled to second interface 820. Note that other architectures than the point-to-point architecture described above are possible. For example, instead of the point-to-point architecture, a system such as multiprocessor system 800 may implement a multi-drop interface or other such architecture.

Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 9 illustrates a block diagram of an example processor and/or SoC 900 that may have one or more cores and an integrated memory controller. The solid lined boxes illustrate a processor 900 with a single core 902(A), system agent unit circuitry 910, and a set of one or more interface controller unit(s) circuitry 916, while the optional addition of the dashed lined boxes illustrates an alternative processor 900 with multiple cores 902(A)-(N), a set of one or more integrated memory controller unit(s) circuitry 914 in the system agent unit circuitry 910, and special purpose logic 908, as well as a set of one or more interface controller units circuitry 916. Note that the processor 900 may be one of the processors 870 or 880, or co-processor 838 or 815 of FIG. 8.

Thus, different implementations of the processor 900 may include: 1) a CPU with the special purpose logic 908 being integrated graphics and/or scientific (throughput) logic (which may include one or more cores, not shown), and the cores 902(A)-(N) being one or more general purpose cores (e.g., general purpose in-order cores, general purpose out-of-order cores, or a combination of the two); 2) a coprocessor with the cores 902(A)-(N) being a large number of special purpose cores intended primarily for graphics and/or scientific (throughput); and 3) a coprocessor with the cores 902(A)-(N) being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 904(A)-(N) within the cores 902(A)-(N), a set of one or more shared cache unit(s) circuitry 906, and external memory (not shown) coupled to the set of integrated memory controller unit(s) circuitry 914. The set of one or more shared cache unit(s) circuitry 906 may include one or more mid-level caches, such as level 2 (L2), level 3 (L3), level 4 (L4), or other levels of cache, such as a last level cache (LLC), and/or combinations thereof. While in some examples interface network circuitry 912 (e.g., a ring interconnect) interfaces the special purpose logic 908 (e.g., integrated graphics logic), the set of shared cache unit(s) circuitry 906, and the system agent unit circuitry 910, alternative examples use any number of well-known techniques for interfacing such units. In some examples, coherency is maintained between one or more of the shared cache unit(s) circuitry 906 and cores 902(A)-(N). In some examples, interface controller units circuitry 916 couple the cores 902 to one or more other devices 918 such as one or more I/O devices, storage, one or more communication devices (e.g., wireless networking, wired networking, etc.), etc.

In some examples, one or more of the cores 902(A)-(N) are capable of multi-threading. The system agent unit circuitry 910 includes those components coordinating and operating cores 902(A)-(N). The system agent unit circuitry 910 may include, for example, power control unit (PCU) circuitry and/or display unit circuitry (not shown). The PCU may be or may include logic and components needed for regulating the power state of the cores 902(A)-(N) and/or the special purpose logic 908 (e.g., integrated graphics logic). The display unit circuitry is for driving one or more externally connected displays.

The cores 902(A)-(N) may be homogenous in terms of instruction set architecture (ISA). Alternatively, the cores 902(A)-(N) may be heterogeneous in terms of ISA; that is, a subset of the cores 902(A)-(N) may be capable of executing an ISA, while other cores may be capable of executing only a subset of that ISA or another ISA.

Example Core Architectures—In-Order and Out-of-Order Core Block Diagram.

FIG. 10A is a block diagram illustrating both an example in-order pipeline and an example register renaming, out-of-order issue/execution pipeline according to examples. FIG. 10B is a block diagram illustrating both an example in-order architecture core and an example register renaming, out-of-order issue/execution architecture core to be included in a processor according to examples. The solid lined boxes in FIGS. 10A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10A, a processor pipeline 1000 includes a fetch stage 1002, an optional length decoding stage 1004, a decode stage 1006, an optional allocation (Alloc) stage 1008, an optional renaming stage 1010, a schedule (also known as a dispatch or issue) stage 1012, an optional register read/memory read stage 1014, an execute stage 1016, a write back/memory write stage 1018, an optional exception handling stage 1022, and an optional commit stage 1024. One or more operations can be performed in each of these processor pipeline stages. For example, during the fetch stage 1002, one or more instructions are fetched from instruction memory, and during the decode stage 1006, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1006 and the register read/memory read stage 1014 may be combined into one pipeline stage. In one example, during the execute stage 1016, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 10B may implement the pipeline 1000 as follows: 1) the instruction fetch circuitry 1038 performs the fetch and length decoding stages 1002 and 1004; 2) the decode circuitry 1040 performs the decode stage 1006; 3) the rename/allocator unit circuitry 1052 performs the allocation stage 1008 and renaming stage 1010; 4) the scheduler(s) circuitry 1056 performs the schedule stage 1012; 5) the physical register file(s) circuitry 1058 and the memory unit circuitry 1070 perform the register read/memory read stage 1014; the execution cluster(s) 1060 perform the execute stage 1016; 6) the memory unit circuitry 1070 and the physical register file(s) circuitry 1058 perform the write back/memory write stage 1018; 7) various circuitry may be involved in the exception handling stage 1022; and 8) the retirement unit circuitry 1054 and the physical register file(s) circuitry 1058 perform the commit stage 1024.

FIG. 10B shows a processor core 1090 including front-end unit circuitry 1030 coupled to execution engine unit circuitry 1050, and both are coupled to memory unit circuitry 1070. The core 1090 may be a reduced instruction set architecture computing (RISC) core, a complex instruction set architecture computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front-end unit circuitry 1030 may include branch prediction circuitry 1032 coupled to instruction cache circuitry 1034, which is coupled to an instruction translation lookaside buffer (TLB) 1036, which is coupled to instruction fetch circuitry 1038, which is coupled to decode circuitry 1040. In one example, the instruction cache circuitry 1034 is included in the memory unit circuitry 1070 rather than the front-end circuitry 1030. The decode circuitry 1040 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1040 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1040 may be implemented using various different mechanisms. Examples of suitable mechanisms include, but are not limited to, look-up tables, hardware implementations, programmable logic arrays (PLAs), microcode read only memories (ROMs), etc. In one example, the core 1090 includes a microcode ROM (not shown) or other medium that stores microcode for certain macroinstructions (e.g., in decode circuitry 1040 or otherwise within the front-end circuitry 1030). In one example, the decode circuitry 1040 includes a micro-operation (micro-op) or operation cache (not shown) to hold/cache decoded operations, micro-tags, or micro-operations generated during the decode or other stages of the processor pipeline 1000. The decode circuitry 1040 may be coupled to rename/allocator unit circuitry 1052 in the execution engine circuitry 1050.

The execution engine circuitry 1050 includes the rename/allocator unit circuitry 1052 coupled to retirement unit circuitry 1054 and a set of one or more scheduler(s) circuitry 1056. The scheduler(s) circuitry 1056 represents any number of different schedulers, including reservations stations, central instruction window, etc. In some examples, the scheduler(s) circuitry 1056 can include arithmetic logic unit (ALU) scheduler/scheduling circuitry, ALU queues, address generation unit (AGU) scheduler/scheduling circuitry, AGU queues, etc. The scheduler(s) circuitry 1056 is coupled to the physical register file(s) circuitry 1058. Each of the physical register file(s) circuitry 1058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1058 includes vector registers unit circuitry, writemask registers unit circuitry, and scalar register unit circuitry. These register units may provide architectural vector registers, vector mask registers, general-purpose registers, etc. The physical register file(s) circuitry 1058 is coupled to the retirement unit circuitry 1054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1054 and the physical register file(s) circuitry 1058 are coupled to the execution cluster(s) 1060. The execution cluster(s) 1060 includes a set of one or more execution unit(s) circuitry 1062 and a set of one or more memory access circuitry 1064. The execution unit(s) circuitry 1062 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1056, physical register file(s) circuitry 1058, and execution cluster(s) 1060 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1064). It should also be understood that where separate pipelines are used, one or more of these pipelines may be out-of-order issue/execution and the rest in-order.

In some examples, the execution engine unit circuitry 1050 may perform load store unit (LSU) address/data pipelining to an Advanced Microcontroller Bus (AMB) interface (not shown), and address phase and writeback, data phase load, store, and branches.

The set of memory access circuitry 1064 is coupled to the memory unit circuitry 1070, which includes data TLB circuitry 1072 coupled to data cache circuitry 1074 coupled to level 2 (L2) cache circuitry 1076. In one example, the memory access circuitry 1064 may include load unit circuitry, store address unit circuitry, and store data unit circuitry, each of which is coupled to the data TLB circuitry 1072 in the memory unit circuitry 1070. The instruction cache circuitry 1034 is further coupled to the level 2 (L2) cache circuitry 1076 in the memory unit circuitry 1070. In one example, the instruction cache 1034 and the data cache 1074 are combined into a single instruction and data cache (not shown) in L2 cache circuitry 1076, level 3 (L3) cache circuitry (not shown), and/or main memory. The L2 cache circuitry 1076 is coupled to one or more other levels of cache and eventually to a main memory.

The core 1090 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1090 includes logic to support a packed data instruction set architecture extension (e.g., AVX1, AVX2), thereby allowing the operations used by many multimedia applications to be performed using packed data.

Example Execution Unit(s) Circuitry.

FIG. 11 illustrates examples of execution unit(s) circuitry, such as execution unit(s) circuitry 1062 of FIG. 10B. As illustrated, execution unit(s) circuitry 1062 may include one or more ALU circuits 1101, optional vector/single instruction multiple data (SIMD) circuits 1103, load/store circuits 1105, branch/jump circuits 1107, and/or Floating-point unit (FPU) circuits 1109. ALU circuits 1101 perform integer arithmetic and/or Boolean operations. Vector/SIMD circuits 1103 perform vector/SIMD operations on packed data (such as SIMD/vector registers). Load/store circuits 1105 execute load and store instructions to load data from memory into registers or store from registers to memory. Load/store circuits 1105 may also generate addresses. Branch/jump circuits 1107 cause a branch or jump to a memory address depending on the instruction. FPU circuits 1109 perform floating-point arithmetic. The width of the execution unit(s) circuitry 1062 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Example Register Architecture.

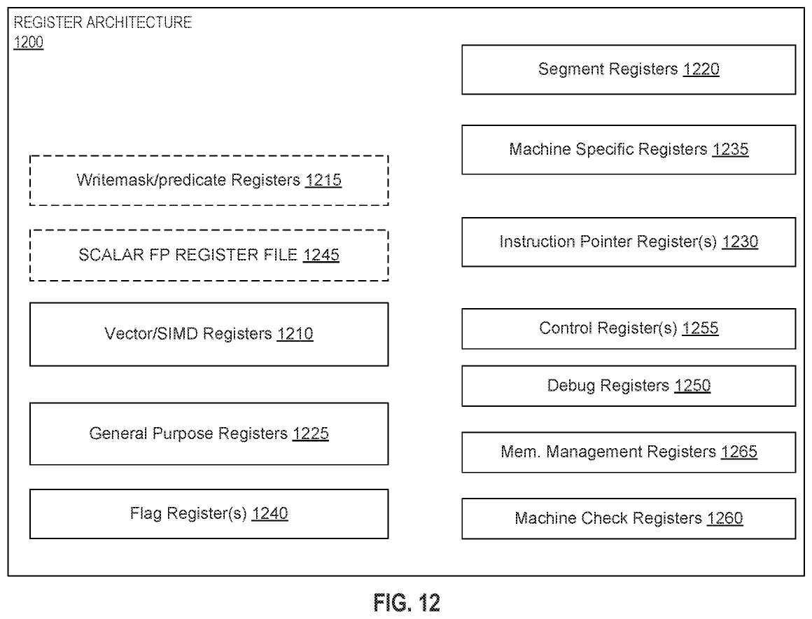

FIG. 12 is a block diagram of a register architecture 1200 according to some examples. As illustrated, the register architecture 1200 includes vector/SIMD registers 1210 that vary from 128-bit to 1,024 bits width. In some examples, the vector/SIMD registers 1210 are physically 512-bits and, depending upon the mapping, only some of the lower bits are used. For example, in some examples, the vector/SIMD registers 1210 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1200 includes writemask/predicate registers 1215. For example, in some examples, there are 8 writemask/predicate registers (sometimes called k0 through k7) that are each 16-bit, 32-bit, 64-bit, or 128-bit in size. Writemask/predicate registers 1215 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1215 corresponds to a data element position of the destination. In other examples, the writemask/predicate registers 1215 are scalable and consists of a set number of enable bits for a given vector element (e.g., 8 enable bits per 64-bit vector element).

The register architecture 1200 includes a plurality of general-purpose registers 1225. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1200 includes scalar floating-point (FP) register file 1245 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1240 (e.g., EFLAGS, RFLAGS, etc.) store status and control information for arithmetic, compare, and system operations. For example, the one or more flag registers 1240 may store condition code information such as carry, parity, auxiliary carry, zero, sign, and overflow. In some examples, the one or more flag registers 1240 are called program status and control registers.

Segment registers 1220 contain segment points for use in accessing memory. In some examples, these registers are referenced by the names CS, DS, SS, ES, FS, and GS.

Machine specific registers (MSRs) 1235 control and report on processor performance. Most MSRs 1235 handle system-related functions and are not accessible to an application program. Machine check registers 1260 consist of control, status, and error reporting MSRs that are used to detect and report on hardware errors.

One or more instruction pointer register(s) 1230 store an instruction pointer value. Control register(s) 1255 (e.g., CR0-CR4) determine the operating mode of a processor (e.g., processor 870, 880, 838, 815, and/or 900) and the characteristics of a currently executing task. Debug registers 1250 control and allow for the monitoring of a processor or core's debugging operations.

Memory (mem) management registers 1265 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1200 may, for example, be used in register file/memory, or physical register file(s) circuitry 10 58.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 13 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 13 shows a program in a high-level language 1302 may be compiled using a first ISA compiler 1304 to generate first ISA binary code 1306 that may be natively executed by a processor with at least one first ISA core 1316. The processor with at least one first ISA core 1316 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1304 represents a compiler that is operable to generate first ISA binary code 1306 (e.g., object code) that can, with or without additional linkage processing, be executed on the processor with at least one first ISA core 1316. Similarly, FIG. 13 shows the program in the high-level language 1302 may be compiled using an alternative ISA compiler 1308 to generate alternative ISA binary code 1310 that may be natively executed by a processor without a first ISA core 1314. The instruction converter 1312 is used to convert the first ISA binary code 1306 into code that may be natively executed by the processor without a first ISA core 1314. This converted code is not necessarily to be the same as the alternative ISA binary code 1310; however, the converted code will accomplish the general operation and be made up of instructions from the alternative ISA. Thus, the instruction converter 1312 represents software, firmware, hardware, or a combination thereof that, through emulation, simulation or any other process, allows a processor or other electronic device that does not have a first ISA processor or core to execute the first ISA binary code 1306.

Techniques and architectures for fast recovery from a branch misprediction are described herein. In the above description, for purposes of explanation, numerous specific details are set forth in order to provide a thorough understanding of certain examples. It will be apparent, however, to one skilled in the art that certain examples can be practiced without these specific details. In other instances, structures and devices are shown in block diagram form in order to avoid obscuring the description

### ADDITIONAL NOTES AND EXAMPLES

Example 1 includes an integrated circuit, comprising a first execution cluster, a second execution cluster that is one or more of narrower and shallower as compared to the first execution cluster, and circuitry to selectively steer instructions to the first execution cluster and the second execution cluster based on branch misprediction information.

Example 2 includes the integrated circuit of Example 1, wherein the circuitry is further to identify one or more instructions as part of a characteristic branch sequence, and steer the identified one or more instructions to the second execution cluster.

Example 3 includes the integrated circuit of Example 2, wherein the circuitry is further to identify a frequently mis-predicted branch, form a back-slice chain of instructions that lead up to the frequently mis-predicted branch, and identify one or more instructions in the back-slice chain as part of the characteristic branch sequence to be steered to the second execution cluster.

Example 4 includes the integrated circuit of any of Examples 2 to 3, wherein the circuitry is further to identify a correct branch after a mis-predicted branch, and identify two or more instructions in the correct branch as part of the characteristic branch sequence to be steered to the second execution cluster.

Example 5 includes the integrated circuit of any of Examples 1 to 4, wherein the first execution cluster comprises eight or more execution ports and wherein the second execution cluster comprises less than eight execution ports.

Example 6 includes the integrated circuit of Example 5, wherein the second execution cluster comprises four or less execution ports.

Example 7 includes the integrated circuit of any of Examples 1 to 6, wherein the first execution cluster comprises one hundred or more reservation station entries per port and wherein the second execution cluster comprises less than one hundred reservation station entries per port.

Example 8 includes the integrated circuit of Example 7, wherein the second execution cluster comprises thirty two or less reservation station entries per port.

Example 9 includes the integrated circuit of any of Examples 1 to 8, wherein the second execution cluster has a shorter pipeline of execution as compared to the first execution cluster.

Example 10 includes a method, comprising determining branch misprediction information, and selectively steering instructions to one of a first execution cluster and a second execution cluster based on the branch misprediction information, wherein the second execution cluster is one or more of narrower and shallower as compared to the first execution cluster.

Example 11 includes the method of Example 10, further comprising identifying one or more instructions as part of a characteristic branch sequence, and steering the identified one or more instructions to the second execution cluster.

Example 12 includes the method of Example 11, further comprising identifying a frequently mis-predicted branch, forming a back-slice chain of instructions that lead up to the frequently mis-predicted branch, and identifying one or more instructions in the back-slice chain as part of the characteristic branch sequence to be steered to the second execution cluster.

Example 13 includes the method of any of Examples 11 to 12, further comprising identifying a correct branch after a mis-predicted branch, and identifying two or more instructions in the correct branch as part of the characteristic branch sequence to be steered to the second execution cluster.

Example 14 includes the method of any of Examples 10 to 13, wherein the first execution cluster comprises eight or more execution ports and wherein the second execution cluster comprises less than eight execution ports.

Example 15 includes the method of Example 14, wherein the second execution cluster comprises four or less execution ports.

Example 16 includes the method of any of Examples 10 to 15, wherein the first execution cluster comprises one hundred or more reservation station entries per port and wherein the second execution cluster comprises less than one hundred reservation station entries per port.

Example 17 includes the method of Example 16, wherein the second execution cluster comprises thirty two or less reservation station entries per port.

Example 18 includes the method of any of Examples 10 to 17, wherein the second execution cluster has a shorter pipeline of execution as compared to the first execution cluster.

Example 19 includes an apparatus, comprising a front-end unit to decode one or more instructions, an execution engine unit communicatively coupled to the front-end unit to execute one or more decoded instructions, the execution engine unit including a first execution cluster and a second execution cluster that is one or more of narrower and shallower as compared to the first execution cluster, and circuitry to selectively steer instructions to the first execution cluster and the second execution cluster based on branch misprediction information.

Example 20 includes the apparatus of Example 19, wherein the circuitry is further to identify one or more instructions as part of a characteristic branch sequence, and steer the identified one or more instructions to the second execution cluster.

Example 21 includes the apparatus of Example 20, wherein the circuitry is further to identify a frequently mis-predicted branch, form a back-slice chain of instructions that lead up to the frequently mis-predicted branch, and identify one or more instructions in the back-slice chain as part of the characteristic branch sequence to be steered to the second execution cluster.

Example 22 includes the apparatus of any of Examples 20 to 21, wherein the circuitry is further to identify a correct branch after a mis-predicted branch, and identify two or more instructions in the correct branch as part of the characteristic branch sequence to be steered to the second execution cluster.

Example 23 includes the apparatus of any of Examples 19 to 22, wherein the first execution cluster comprises eight or more execution ports and wherein the second execution cluster comprises less than eight execution ports.

Example 24 includes the apparatus of Example 23, wherein the second execution cluster comprises four or less execution ports.

Example 25 includes the apparatus of any of Examples 19 to 25, wherein the first execution cluster comprises one hundred or more reservation station entries per port and wherein the second execution cluster comprises less than one hundred reservation station entries per port.

Example 26 includes the apparatus of Example 25, wherein the second execution cluster comprises thirty two or less reservation station entries per port.

Example 27 includes the apparatus of any of Examples 19 to 26, wherein the second execution cluster has a shorter pipeline of execution as compared to the first execution cluster.

Example 28 includes an apparatus, comprising means for determining branch misprediction information, and means for selectively steering instructions to one of a first execution cluster and a second execution cluster based on the branch misprediction information, wherein the second execution cluster is one or more of narrower and shallower as compared to the first execution cluster.

Example 29 includes the apparatus of Example 28, further comprising means for identifying one or more instructions as part of a characteristic branch sequence, and means for steering the identified one or more instructions to the second execution cluster.

Example 30 includes the apparatus of Example 29, further comprising means for identifying a frequently mis-predicted branch, means for forming a back-slice chain of instructions that lead up to the frequently mis-predicted branch, and means for identifying one or more instructions in the back-slice chain as part of the characteristic branch sequence to be steered to the second execution cluster.

Example 31 includes the apparatus of any of Examples 29 to 30, further comprising means for identifying a correct branch after a mis-predicted branch, and means for identifying two or more instructions in the correct branch as part of the characteristic branch sequence to be steered to the second execution cluster.

Example 32 includes the apparatus of any of Examples 28 to 31, wherein the first execution cluster comprises eight or more execution ports and wherein the second execution cluster comprises less than eight execution ports.

Example 33 includes the apparatus of Example 32, wherein the second execution cluster comprises four or less execution ports.

Example 34 includes the apparatus of any of Examples 28 to 33, wherein the first execution cluster comprises one hundred or more reservation station entries per port and wherein the second execution cluster comprises less than one hundred reservation station entries per port.

Example 35 includes the apparatus of Example 34, wherein the second execution cluster comprises thirty two or less reservation station entries per port.

Example 36 includes the apparatus of any of Examples 28 to 35, wherein the second execution cluster has a shorter pipeline of execution as compared to the first execution cluster.

Example 37 includes at least one non-transitory one machine readable medium comprising a plurality of instructions that, in response to being executed on a computing device, cause the computing device to determine branch misprediction information, and selectively steer instructions to one of a first execution cluster and a second execution cluster based on the branch misprediction information, wherein the second execution cluster is one or more of narrower and shallower as compared to the first execution cluster.

Example 38 includes the at least one non-transitory one machine readable medium of Example 37, comprising a plurality of further instructions that, in response to being executed on the computing device, cause the computing device to identify one or more instructions as part of a characteristic branch sequence, and steer the identified one or more instructions to the second execution cluster.

Example 39 includes the at least one non-transitory one machine readable medium of Example 38, comprising a plurality of further instructions that, in response to being executed on the computing device, cause the computing device to identify a frequently mis-predicted branch, form a back-slice chain of instructions that lead up to the frequently mis-predicted branch, and identify one or more instructions in the back-slice chain as part of the characteristic branch sequence to be steered to the second execution cluster.

Example 40 includes the at least one non-transitory one machine readable medium of any of Examples 38 to 39, comprising a plurality of further instructions that, in response to being executed on the computing device, cause the computing device to identify a correct branch after a mis-predicted branch, and identify two or more instructions in the correct branch as part of the characteristic branch sequence to be steered to the second execution cluster.

Example 41 includes the at least one non-transitory one machine readable medium of any of Examples 37 to 40, wherein the first execution cluster comprises eight or more execution ports and wherein the second execution cluster comprises less than eight execution ports.

Example 42 includes the at least one non-transitory one machine readable medium of Example 41, wherein the second execution cluster comprises four or less execution ports.

Example 43 includes the at least one non-transitory one machine readable medium of any of Examples 37 to 42, wherein the first execution cluster comprises one hundred or more reservation station entries per port and wherein the second execution cluster comprises less than one hundred reservation station entries per port.

Example 44 includes the at least one non-transitory one machine readable medium of Example 43, wherein the second execution cluster comprises thirty two or less reservation station entries per port.

Example 45 includes the at least one non-transitory one machine readable medium of any of Examples 37 to 44, wherein the second execution cluster has a shorter pipeline of execution as compared to the first execution cluster.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain examples also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain examples are not described with reference to any particular programming language. It will be appreciated that a variety of programming languages may be used to implement the teachings of such examples as described herein.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus, comprising:
a first execution circuit;
a second execution circuit that is one or more of narrower and shallower as compared to the first execution circuit; and
circuitry to selectively steer instructions to the first execution circuit and the second execution circuit based on branch misprediction information.

2. The apparatus of claim 1, wherein the circuitry is further to:
identify one or more instructions as part of a characteristic branch sequence; and
steer the identified one or more instructions to the second execution circuit.

3. The apparatus of claim 2, wherein the circuitry is further to:
identify a frequently mis-predicted branch;
form a back-slice chain of instructions that lead up to the frequently mis-predicted branch; and
identify one or more instructions in the back-slice chain as part of the characteristic branch sequence to be steered to the second execution circuit.

4. The apparatus of claim 2, wherein the circuitry is further to:
identify a correct branch after a mis-predicted branch; and
identify two or more instructions in the correct branch as part of the characteristic branch sequence to be steered to the second execution circuit.

5. The apparatus of claim 1, wherein the first execution circuit comprises eight or more execution inputs and wherein the second execution circuit comprises less than eight execution inputs.

6. The apparatus of claim 5, wherein the second execution circuit comprises four or less execution inputs.

7. The apparatus of claim 1, wherein the first execution circuit comprises one hundred or more reservation station entries per execution input and wherein the second execution circuit comprises less than one hundred reservation station entries per execution input.

8. The apparatus of claim 7, wherein the second execution circuit comprises thirty two or less reservation station entries per execution input.

9. The integrated circuit of claim 1, wherein the second execution circuit has a shorter pipeline of execution as compared to the first execution circuit.

10. At least one non-transitory one machine readable medium comprising a plurality of instructions that, in response to being executed on a computing device, cause the computing device to:
determine branch misprediction information; and
selectively steer instructions to one of a first execution circuit and a second execution circuit based on the branch misprediction information, wherein the second execution circuit is one or more of narrower and shallower as compared to the first execution circuit.

11. The at least one non-transitory one machine readable medium of claim 10, comprising a plurality of further instructions that, in response to being executed on the computing device, cause the computing device to:
identify one or more instructions as part of a characteristic branch sequence; and
steer the identified one or more instructions to the second execution circuit.

12. The at least one non-transitory one machine readable medium of claim 11, comprising a plurality of further instructions that, in response to being executed on the computing device, cause the computing device to:
identify a frequently mis-predicted branch;
form a back-slice chain of instructions that lead up to the frequently mis-predicted branch; and
identify one or more instructions in the back-slice chain as part of the characteristic branch sequence to be steered to the second execution circuit.

13. The at least one non-transitory one machine readable medium of claim 11, comprising a plurality of further instructions that, in response to being executed on the computing device, cause the computing device to:
identify a correct branch after a mis-predicted branch; and
identify two or more instructions in the correct branch as part of the characteristic branch sequence to be steered to the second execution circuit.

14. The at least one non-transitory one machine readable medium of claim 10, wherein the first execution circuit comprises eight or more execution ports and wherein the second execution circuit comprises less than eight execution ports and wherein the second execution circuit comprises thirty two or less reservation station entries per port.

15. The at least one non-transitory one machine readable medium of claim 10, wherein the second execution circuit has a shorter pipeline of execution as compared to the first execution circuit.

16. An apparatus, comprising:
a front-end unit to decode one or more instructions;
an execution engine unit communicatively coupled to the front-end unit to execute one or more decoded instructions, the execution engine unit including a first execution circuit and a second execution circuit that is smaller as compared to the first execution circuit; and
circuitry to selectively steer instructions to the first execution circuit and the second execution circuit based on branch misprediction information.

17. The apparatus of claim 16, wherein the circuitry is further to:
identify one or more instructions as part of a characteristic branch sequence; and
steer the identified one or more instructions to the second execution circuit.

18. The apparatus of claim 17, wherein the circuitry is further to:
identify a frequently mis-predicted branch;
form a back-slice chain of instructions that lead up to the frequently mis-predicted branch; and
identify one or more instructions in the back-slice chain as part of the characteristic branch sequence to be steered to the second execution circuit.

19. The apparatus of claim 17, wherein the circuitry is further to:
identify a correct branch after a mis-predicted branch; and
identify two or more instructions in the correct branch as part of the characteristic branch sequence to be steered to the second execution circuit.

20. The apparatus of claim 16, wherein the first execution circuit comprises eight or more execution ports and wherein the second execution circuit comprises four or less execution ports.

21. The apparatus of claim 16, wherein the first execution circuit comprises one hundred or more reservation station entries per port and wherein the second execution circuit comprises thirty two or less reservation station entries per port.

22. The apparatus of claim 16, wherein the second execution circuit has a shorter pipeline of execution as compared to the first execution circuit.
